(19) United States
(12) Patent Application Publication
(10) Pub. No.: US 2020/0166220 A1
(43) Pub. Date: May 28, 2020

(54) INDUCTION COOKTOP

(71) Applicant: Whirlpool Corporation, Benton Harbor, MI (US)

(72) Inventors: Davide Altamura, Fabriano (IT); Diego Bariviera, Fabriano (IT); Alessio Beato, Fabriano (IT)

(73) Assignee: Whirlpool Corporation, Benton Harbor, MI (US)

(21) Appl. No.: 16/774,740

(22) Filed: Jan. 28, 2020

Related U.S. Application Data
(62) Division of application No. 14/883,848, filed on Oct. 15, 2015, now Pat. No. 10,605,464.
Application No. 14/883,848 is a continuation-in-part of application No. 14/435,814, filed on Apr. 15, 2015.

(30) Foreign Application Priority Data
Oct. 15, 2012 (IT) TO2012A000896

(51) Int. Cl. F24C 15/10; H05B 6/06

(52) U.S. Cl. CPC F24C 15/107; H05B 2213/05; H05B 6/062; F24C 15/106

(57) ABSTRACT

An induction cooktop includes a ceramic cooking surface in connection with a housing. A plurality of inductors is disposed in the housing and each of the inductors is in communication with a controller. The controller is configured to selectively activate each of the inductors in response to an input received at the user interface identifying an active inductor of the plurality of inductors to activate. The controller is further configured to detect a presence of a pan proximate the active inductor in response to a detection signal and identify a small pan condition in response to a phase angle detected for the active inductor of the plurality of inductors.

### CROSS-REFERENCE TO RELATED APPLICATIONS

The present application is a division of U.S. application Ser. No. 14/883,848 entitled “INDUCTION COOKTOP” and filed Oct. 15, 2015, now U.S. Patent Application Publication No. 2016/0037589 A1, which is a continuation-in-part of U.S. application Ser. No. 14/435,814, entitled “INDUCTION COOKING TOP” and filed Oct. 14, 2013, now U.S. Patent Application Publication No. 2015/0295470 A1, which is a National Phase Entry of International Application No. PCT/IB2013/059340 filed Oct. 14, 2013, which claims priority to Italian Application No. TO2012A000896 filed Oct. 15, 2012.

### FIELD OF THE INVENTION

The present disclosure relates to an induction cooktop and more particularly to a controller for an induction cooktop.

### BACKGROUND

Induction cooktops are devices which exploit the phenomenon of induction heating for food cooking purposes. Induction cooktops comprise a top made of glass-ceramic material upon which cooking units are positioned (hereinafter “pans”). Moreover there are provided inductors comprising coils of copper wire where an oscillating current (e.g. an alternating current) is circulated producing an oscillating electromagnetic field.

The electromagnetic field has the main effect of inducing a parasitic current inside the pan, which is made of an electrically conductive ferromagnetic material. The parasitic current circulating in the pan produces heat by dissipation; such heat is generated only within the pan and it acts without heating the cooktop.

This type of flameless cooktop has a better efficiency than electric cooktops (i.e. a greater fraction of the absorbed electric power is converted into heat that heats the pan). In addition, induction cooktops are safer to use due to the absence of hot surfaces or flames, reducing the risk of burns for the user or of fire. The presence of the pan on the cooktop causes the magnetic flux close to the pan itself causing the power to be transferred towards the pan. The greater the size of the pan, the higher the power that can be transferred.

Since heat is generated by induced currents, a cooktop control system may be utilized to monitor currents flowing through the coils; in this way, the power supplied to each inductor can be adjusted. Moreover such current monitoring may provide for the control system to automatically detect a presence of a pan over the inductors and to automatically turn off the inductors in response to the absence of the pan on the cooktop. A drawback arising from the automatic detection, is that it is possible for small pans not to be detected by the control system. In such conditions, the presence of a small pan that is not detected by the control system may lead to the cooktop control system failing to activate the inductors. That is, the control system may fail to activate the passage of the current through the coils of the inductors and fail to heat the small pan.

The disclosure provides for a control system configured to provide an improved method of presence detection for pans, particularly small pans. The modification provides for improved detection and operation of an induction cooktop.

### SUMMARY

According to one aspect of the present invention, an induction cooktop is disclosed. The induction cooktop comprises a ceramic cooking surface in connection with a housing. A plurality of inductors is disposed in the housing and each of the inductors is in communication with a controller. The controller is configured to selectively activate each of the inductors in response to an input received at the user interface identifying an active inductor of the plurality of inductors to activate. The controller is further configured to detect a presence of a pan proximate the active inductor in response to a detection signal and identify a small pan condition in response to a phase angle detected for the active inductor of the plurality of inductors.

According to another aspect of the present invention, a method of controlling a cooktop is disclosed. The method comprises selectively activating an active inductor in response to an input received at a user interface and detecting a presence of a pan proximate the active inductor in response to a detection signal. The method further comprises identifying a small pan condition in response to a phase angle detected for the active inductor. The phase angle is between a zero-crossing of an induced current and a leading edge of a voltage across an inverter switch configured to provide current to the active inductor.

According to yet another aspect of the present invention, a controller for identifying a small pan condition for an induction cooktop is disclosed. The controller is in communication with a plurality of inductors, an inverter switch, and a user interface. The controller is configured to selectively activate each of the inductors in response to an input received at the user interface identifying an active inductor of the plurality of inductors to activate. The controller is further configured to detect a presence of a pan proximate the active inductor in response to a detection signal. The controller is further configured to identify the small pan condition in response to a phase angle identified between a zero-crossing of an induced current and a leading edge of a voltage across the inverter switch.

These and other objects of the present disclosure may be achieved by means of a cooktop incorporating the features set out in the appended claims, which are an integral part of the present description.

### BRIEF DESCRIPTION OF THE DRAWINGS

Further objects and advantages of the present disclosure may become more apparent from the following detailed description and from the annexed drawing, which is provided by way of a non-limiting example, wherein:

FIG. 1 is a top view of a cooktop according to the present disclosure;

FIG. 2 is a schematic representation of an inductor and an example of a driving circuit;

FIG. 3 is a representation of phase control parameter;

FIG. 4 is a plot of prior art control scheme for a controller of an induction cooktop; and

FIG. 5 is a plot of a modified control scheme for a controller of an induction cooktop providing for use of a small pan in accordance with the disclosure.

### DETAILED DESCRIPTION OF EMBODIMENTS

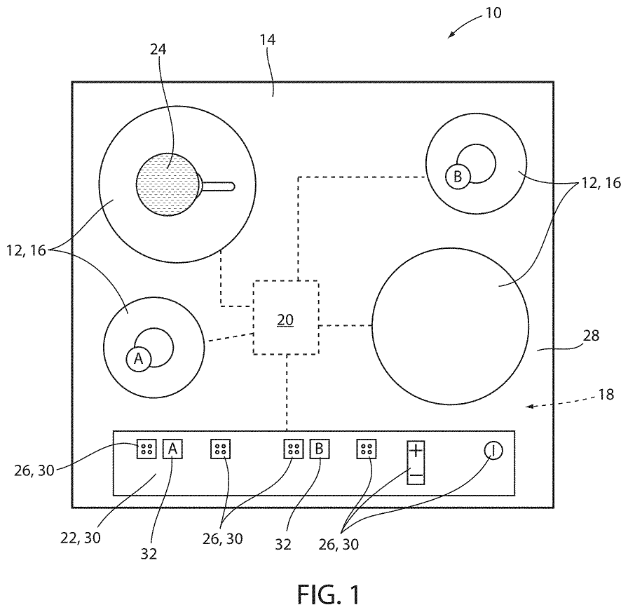

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, a top view of a cooktop 10 is shown. The cooktop 10 may comprise a plurality of cooking hobs 12 oriented on a ceramic plate 14. Beneath the ceramic plate 14 and corresponding to each of the hobs 12, a plurality of induction coils 16 may be disposed in a housing 18. The induction coils 16 may be in communication with a controller 20 configured to selectively activate the induction coils 16 in response to an input to a user interface 22. The controller 20 may correspond to an automatic control system configured to activate one or more of the induction coils 16 in response to an input or user selection. Additionally, the controller 20 may only activate an induction coil upon identifying a presence of a ferromagnetic pan 24 proximate a selected hob of the plurality of hobs 12. The disclosure provides for an induction cooktop 10 operable to detect and activate a selected hob in response to the pan 24 corresponding to a small pan. Such pans may not be sensed by conventional induction cooktops due to safety systems that may mistakenly sense that no pan is present.

The user interface 22 may correspond to a touch interface configured to perform heat control and selection of the plurality of hobs 12 as illustrated in a plurality of instructive decals 26 disposed on a cooking surface 28 of the cooktop. The user interface 22 may comprise a plurality of sensors 30 configured to detect a presence of an object, for example a finger of an operator, proximate thereto. The sensors 30 may correspond to any form of sensors. In an exemplary embodiment, the sensors 30 may correspond to capacitive, resistive, and/or optical sensors. In an exemplary embodiment, the sensors 30 correspond to capacitive proximity sensors.

The user interface 22 may further comprise a display 32 configured to communicate at least one function of the cooktop 10. The display may correspond to various forms of displays, for example, light emitting diode (LED) display, a liquid crystal display (LCD), etc. In some embodiments, the display may correspond to a segmented display configured to depict one or more alpha-numeric characters to communicate a cooking function of the cooktop 10. The display may further be operable to communicate one or more error messages or status messages of the cooktop 10.

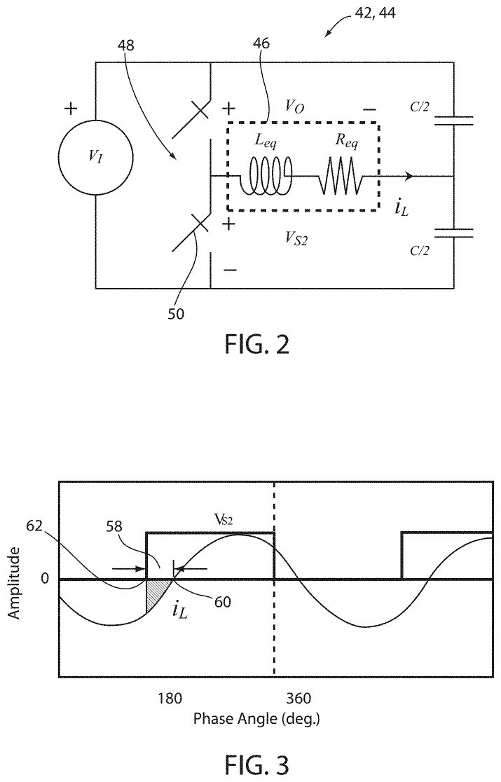

Referring now to FIG. 2, a schematic view of an electronic circuit 42 in communication with the controller 20 is shown. The controller 20 is configured to apply the alternating current to drive each of the induction coils 16. As illustrated, an equivalent circuit model 44 of an exemplary induction coil 46 is shown and denoted as the equivalent inductance L_{eq} and the equivalent resistance R_{eq}. The induction coil is further modeled having the equivalent capacitance C divided in the paths as C/2.

The controller 20 is configured to selectively drive the induction coil 46 in response to a detection of a user input into the user interface 22 and a detection of a pan 24 on the cooking surface 28. The induction coil 46 is driven in this example with a half bridge inverter 48. The controller 20 is configured to monitor the current i_{L} driven through the induction coil 46. Additionally, the controller 20 is configured to monitor the voltage V_{S2} on a lower switch 50 of the half bridge inverter 48. The phase angle between the zero-crossing of the current i_{L} and the leading edge of the square wave of V_{S2} can be derived from the current i_{L} and the voltage V_{S2}. See FIG. 3 for a schematic representation of phase parameter.

Though a half bridge inverter is referred to herein, various driving circuits may be similarly utilized to control the induction coil 46 as described herein. For example, the induction coil 46 may correspond to a full bridge inverter or a quasi-resonant converter. The controller 20 may utilize a variety of sensor circuits to monitor the current i_{L} and the voltage V_{S2}. Additionally, the controller 20 may comprise one or more processors or circuits configured to derive the identify the zero-crossing of the current i_{L} and the leading edge of the voltage V_{S2}.

Referring now to FIG. 3, an exemplary plot of the current i_{L} and the voltage V_{S2} is shown.

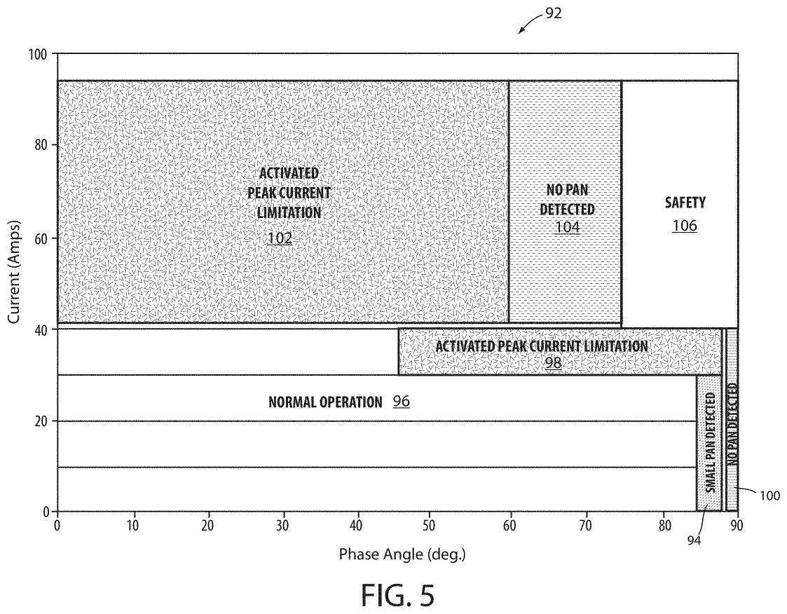

The controller 20 may monitor the phase angle 58 between the zero-crossing 60 of the current i_{L} and the leading edge 62 of the square wave of V_{S2}. Based on the phase angle 58, the controller may identify various states of the cooktop 10. For example, if the phase angle 58 is approximately 90 degrees, the controller 20 may identify that the pan 24 is not present proximate an active or selected induction coil. Additionally, if the phase angle 58 is significantly less than 90 degrees the controller 20 may identify normal operation of the cooktop 10. As discussed in reference to FIG. 5, the controller 20 may be configured to provide for an identification of a pan not being present while providing for operation of the cooktop with the small pan 24.

The phase angle 58 identified in FIG. 3 corresponds to a low phase angle that is significantly less than 90 degrees and may correspond to normal operation of the cooktop 10. The control scheme applied by the controller 20 may provide for the detection of the phase angle 58 as well as the amplitude of the current to distinguish normal operation of the cooktop 10 in accordance with the disclosure. As discussed herein, the controller 20 may provide for the detection of the small pan 24 to improve operation of the cooktop 10 and enable utilization of the small pan 24 to improve the versatility of the cooktop 10.

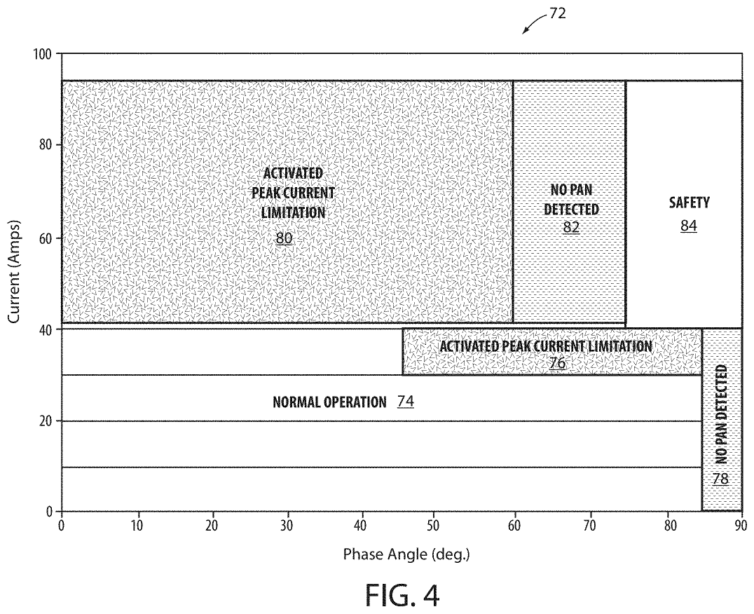

Referring now to FIG. 4, a plot of prior art control scheme 72 for a controller of an induction cooktop is shown. The control scheme 72 utilizes the phase angle between the zero-crossing 60 of the current i_{L} and the leading edge 62 of the square wave of V_{S2} as a first variable. In addition to the phase angle, the control scheme 72 utilizes the current i_{L} drawn by an induction coil to define operating parameters of an induction coil. In this way, the controller may be operable to distinguish normal operation of the cooktop, but may not provide for operation with a small pan.

The normal operation zone 74 of the control scheme 72 may correspond to the phase angle 58 ranging from approximately 0 degrees to 85 degrees with the current i_{L} approximately less than 40 amps. Between a phase angle 58 of approximately 45 degrees and 85 degrees with the current i_{L} approximately between 30 and 40 amps, the controller may activate a peak current limitation 76. Additionally, the controller 20 may identify the phase angle 58 approximately between 85 degrees and 90 degrees with the current i_{L} approximately between 0 and 40 amps as a first no pan detected range 78 of operation. In response to this condition, the controller may fail to activate a selected induction coil even if a small pan is present. As such, the control scheme 72 may fail to provide for operation of an induction cooktop with small pans.

Therefore, the control scheme 72 may not provide for activation of an induction coil in the presence of a pan having such a size to have a surface in contact with the induction cooktop smaller than a size threshold (for example 50 cm²). Such a size threshold may correspond to a working point falling in the area “NO PAN DETECTED” in the PHASE range 85°-90°. This can be an undesired operation, since in this case the user would like the system to operate and to activate; however, the activation may be limited for safety purposes.

The control scheme 72 of the controller may further provide for an activated peak current 80 limitation to be activated in response to the phase angle 58 approximately between 0 degrees and 60 degrees with the current i_{L} approximately between 40 and 95 amps. Additionally, the controller may activate a second no pan detected range 82 of operation in response to the phase angle 58 approximately between 60 degrees and 75 degrees with the current i_{L} approximately between 40 and 95 amps. Finally a safety warning zone 84 may correspond to the phase angle 58 approximately between 75 degrees and 90 degrees with the current i_{L} approximately between 40 and 95 amps.

Referring now to FIG. 5, a plot of a modified control scheme 92 for the controller 20 of the induction cooktop 10 is shown. The control scheme may provide for enhanced operation by including a small pan operating range 94. The modified control scheme 82 similarly utilizes the phase angle between the zero-crossing 60 of the current i_{L} and the leading edge 62 of the square wave of V_{S2} as a first variable. In addition to the phase angle 58, the modified control scheme 82 utilizes the current i_{L} drawn by an induction coil to define operating parameters of an induction coil. As further discussed, the controller 20 may provide for operation of the cooktop with the pan 24 and other small pans.

The normal operation zone 96 of the modified control scheme 92 may correspond to the phase angle 58 ranging from approximately 0 degrees to 85 degrees with the current i_{L} approximately less than 40 amps. Between a phase angle 58 of approximately 45 degrees and 85 degrees with the current i_{L} approximately between 30 and 40 amps, the controller may activate a peak current limitation 98. Additionally, the controller may identify the phase angle 58 approximately between 88 degrees and 90 degrees with the current i_{L} approximately between 0 and 40 amps as a first no pan detected range 100 of operation. In response to this condition, the controller 20 may accurately identify a pan not present proximate a selected induction coil.

The controller 20 may identify the small pan operating range 94 in response to the phase angle 58 approximately between 84 degrees and 88 degrees with the current i_{L} approximately less than 30 amps. The small pan operating range may further correspond to the phase angle 58 approximately between 85 degrees and 87 degrees. In this way, the controller 20 may be advantageously configured to operate at least one induction coil of the cooktop 20 to provide for operation with the small pan 24.

The modified control scheme 92 of the controller 20 may further provide for an activated peak current 102 limitation to be activated in response to the phase angle 58 approximately between 0 degrees and 60 degrees with the current i_{L} approximately between 40 and 95 amps. Additionally, the controller 20 may activate a second no pan detected range 104 of operation in response to the phase angle 58 approximately between 60 degrees and 75 degrees with the current i_{L} approximately between 40 and 95 amps. Finally a safety warning zone 106 may correspond to the phase angle 58 approximately between 75 degrees and 90 degrees with the current i_{L} approximately between 40 and 95 amps.

In some embodiments, the control scheme may further provide for the controller 20 to periodically update to the detection of the small pan periodically during a cooking operation. That is, the controller 20 may continue to periodically monitor the phase angle 58 and the current i_{L} throughout operation of each of the induction coils 16 or inductors of the cooktop 10. In response to identifying an inductor having a phase angle greater than 88 degrees for a predetermined time, the controller 20 may deactivate the inductor. The time interval for the predetermined time may vary. In some implementations, the time interval may be approximately 5 seconds.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only.

Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. An induction cooktop, comprising:
a ceramic cooking surface in connection with a housing;
a plurality of inductors disposed in the housing; and
a controller in communication with the inductors, wherein the controller is configured to:
selectively activate each of the inductors in response to an input received at the user interface identifying an active inductor of the plurality of inductors to activate;
detect a presence of a pan proximate the active inductor in response to a detection signal; and
identify a small pan condition in response to a phase angle detected for the active inductor of the plurality of inductors.

2. The induction cooktop according to claim 1, further comprising:
an inverter comprising at least one inverter switch configured to drive the active inductor.

3. The induction cooktop according to claim 2, wherein the small pan condition is detected in response to a phase angle between a zero-crossing of an induced current and a leading edge of a voltage across the inverter switch.

4. The induction cooktop according to claim 3, wherein the phase angle is identified by determining a zero-crossing of the induced current in the active inductor.

5. The induction cooktop according to claim 3, wherein the phase angle is identified by determining the leading edge of a square wave of the voltage across the inverter switch.

6. The induction cooktop according to claim 3, wherein the controller is configured to identify the small pan condition in response to the phase angle being less than a pan presence threshold.

7. The induction cooktop according to claim 6, wherein the pan presence threshold corresponds to a phase angle approximately less than 88 degrees.

8. The induction cooktop according to claim 6, wherein the pan presence threshold corresponds to a phase angle approximately less than 87 degrees.

9. The induction cooktop according to claim 1, wherein the small pan condition corresponds to the detection of a small pan having a surface approximately less than 50 cm².

10. A method of controlling a cooktop, comprising:
selectively activating an active inductor in response to an input received at a user interface;
detecting a presence of a pan proximate the active inductor in response to a detection signal; and
identifying a small pan condition in response to a phase angle detected for the active inductor, wherein the phase angle is between a zero-crossing of an induced current and a leading edge of a voltage across an inverter switch configured to provide current to the active inductor.

11. The method according to claim 10, wherein the phase angle is identified by determining a zero-crossing of the induced current in the active inductor.

12. The method according to claim 10, wherein the phase angle is identified by determining the leading edge of a square wave of the voltage across the inverter switch.

13. The method according to claim 10, wherein the small pan condition is detected in response to the phase angle being less than a pan presence threshold.

14. The method according to claim 10, further comprising:
identifying the small pan condition in response to the voltage across an inverter switch being less than 30 amps.

15. A controller for identifying a small pan condition for an induction cooktop, the controller in communication with a plurality of inductors, an inverter switch, and a user interface, the controller configured to:
selectively activate each of the inductors in response to an input received at the user interface identifying an active inductor of the plurality of inductors to activate;
detect a presence of a pan proximate the active inductor in response to a detection signal; and
identify the small pan condition in response to a phase angle identified between a zero-crossing of an induced current and a leading edge of a voltage across the inverter switch.

16. The controller according to claim 15, wherein the small pan condition is identified in response to a zero-crossing of the induced current in the active inductor and the leading edge of a square wave of the voltage across the inverter switch, wherein the inverter switch is configured to provide current to the active inductor.

17. The controller according to claim 15, wherein the controller is further configured to:
identify the small pan condition in response to the phase angle being less than a pan presence threshold.

18. The controller according to claim 17, wherein the pan presence threshold corresponds to a phase angle approximately less than 88 degrees.

19. The controller according to claim 15, wherein the controller is further configured to:
periodically update the identification of the presence of the pan during an operation of the active inductor.

20. The controller according to claim 19, wherein the controller is further configured to:
deactivate the active inductor in response to the periodic update detecting the phase angle greater than 88 degrees for a predetermined period of time.
